(19) United States
(12) Patent Application Publication
(10) Pub. No.: US 2013/0000084 A1
(43) Pub. Date: Jan. 3, 2013

(54) SELF-ACTUATING MAGNETIC LOCKING SYSTEM

(76) Inventor: Xavier Abou NASSAR, Montreal (CA)

(21) Appl. No.: 13/532,429

(22) Filed: Jun. 25, 2012

(30) Foreign Application Priority Data
Jun. 29, 2011 (CA) 2745106

(51) Int. Cl. H01F 7/02; F16B 1/00

(52) U.S. Cl. 24/303

(57) ABSTRACT

The present invention relates to a self-actuating magnetic locking mechanism and system for securing two separate components or articles together which includes a manually separable male cylindrical assembly and a female cylindrical assembly.

The male and female cylindrical assemblies each contain permanent magnets and interlocking assemblies. Upon mutual proximity of the said male and female assemblies, magnetic forces will mutually draw and urge the said assemblies into a magnetically held locked condition.

The held locked condition may only be disengaged by a seamless manual counter-clockwise relative rotation of either said male or female assembly and, in conjunction with the relative alignments of the permanent magnets positioned therein, will result with the said male and female assemblies physically repelled from each other by a mutual magnetic repulsive force.

### CROSS-REFERENCE TO RELATED APPLICATIONS

The present application claims the benefit of Canadian Patent Application 2,745,106, filed Jun. 29, 2011, the entirety of which is incorporated herein by reference.

### FIELD OF THE INVENTION

The present invention relates to self-actuating magnetic locking mechanisms and systems for securing two components or articles together, more particularly magnetic locking mechanisms that may be rotationally engaged.

### SUMMARY OF THE INVENTION

The use of magnetic fastening and closure systems including manually separable assemblies are well known in various industries for a number of uses and the grand majority function, more or less, in the same manner.

The assemblies of such magnetic fastening and closure systems are mutually drawn to each other and maintained in a fastened or closed position solely by the force of magnetic attraction. One drawback of such magnetic fastening and closure systems is that they can intentionally or accidentally be released or opened by exterior forces exerted on the assemblies that are superior to the mutual magnetic attractive forces of the assemblies. The release or opening of the magnetic fastening and closure systems is straightforward wherein the assemblies are mutually released by a manual separation force that is greater than the magnetic attraction forces of the assemblies.

A further drawback of these magnetic fastening and closure systems is that they require a harsh and unnatural manual jerking motion in order for the assemblies to be released from their mutual magnetic attraction.

It is an object of the present invention to provide a magnetic and mechanically locked engagement there between the assemblies in order to obstruct the intentional or accidental release or opening by exterior forces exerted on the assemblies that are greater than the magnetic attraction force of the assemblies.

This is accomplished where as the manually separable male and female assemblies are drawn into mutual proximity, a magnetic force will enable either of said assemblies that has unrestrained rotational movement, to revolve into natural magnetic alignment with said other held assembly, magnetically attracting each other and urging the said male and female assemblies into a magnetically held locked condition.

The invention includes a cylindrical projecting male member and a cylindrical female aperture housing assemblies that each contain permanent magnets arranged in a symmetrical polar array of alternating faced polarities.

The locked condition is attained by retractable protruding elements that fully extend in a radial manner beyond either the cylindrical projecting male member wall assembly or the inner cylindrical female aperture housing wall assembly and into the recessed groove openings integrated on the other said assembly wall. This configuration will obstruct the separation of the assemblies by external forces applied that are greater than the magnetic attraction force of the assemblies.

It is a further object of the present invention to provide a seamless magnetic release there between the assemblies in order to eliminate the harsh and unnatural manual jerking motion required to separate the assemblies.

This is accomplished with the present invention wherein the locked condition can only be disengaged by a seamless manual counter-clockwise relative rotation of either said male or female assembly that has unrestrained rotational movement.

This manual counter-clockwise relative rotation will result in the transition of the retractable protruding elements from their natural protruding position inside the groove openings of either the cylindrical projecting male member wall assembly or the inner cylindrical female aperture housing wall assembly to their fully retracted positions inside the other said assembly wall, thus allowing the physical separation of the aforesaid assemblies.

The manual counter-clockwise relative rotation will also result in the permanent magnets contained in both assemblies to enter mutual magnetic repulsion, repelling the male assembly and the female assembly from each other by a mutual magnetic repulsive force.

Other objects, features, and characteristics of the present invention such as low manufacturing costs, will be apparent from the accompanying drawings, and the description that follows.

### BRIEF DESCRIPTION OF THE INVENTION

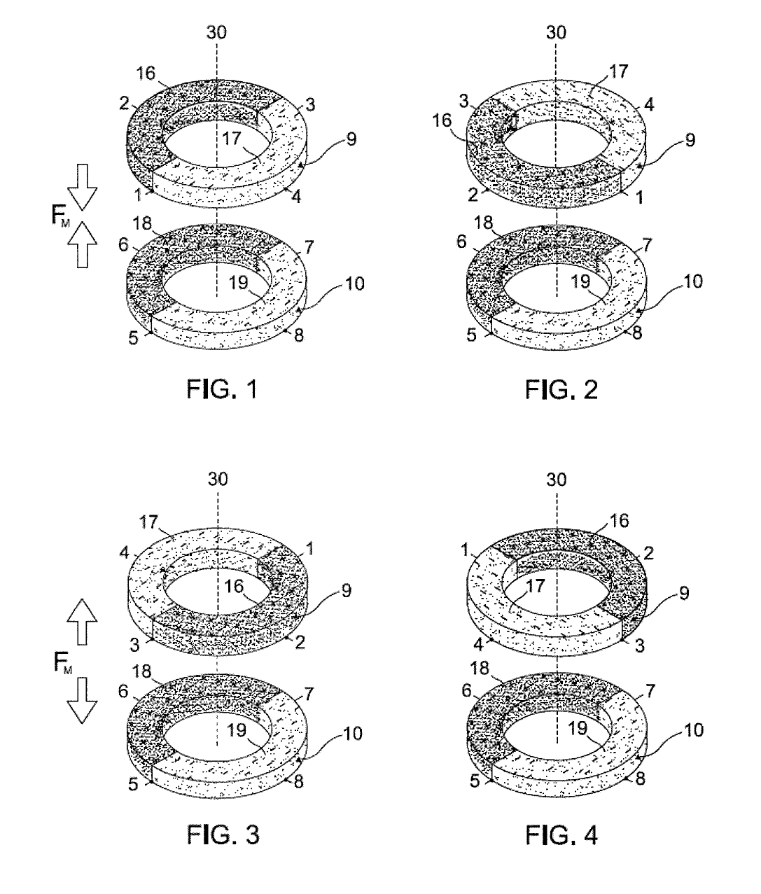

FIG. 1 is a perspective view of an embodiment of the present invention wherein the two separate annular sets of permanent magnets are in natural magnetic alignment;

FIG. 2 is a perspective view of the two separate annular sets of permanent magnets after a relative 90 degree relative counter-clockwise rotation of the upper set of permanent magnets;

FIG. 3 is a perspective view of the two separate annular sets of permanent magnets after a relative 180 degree rotation of the upper set of permanent magnets;

FIG. 4 is a perspective view of the 2 separate annular sets of permanent magnets after a relative 270 degree rotation of the upper set of permanent magnets;

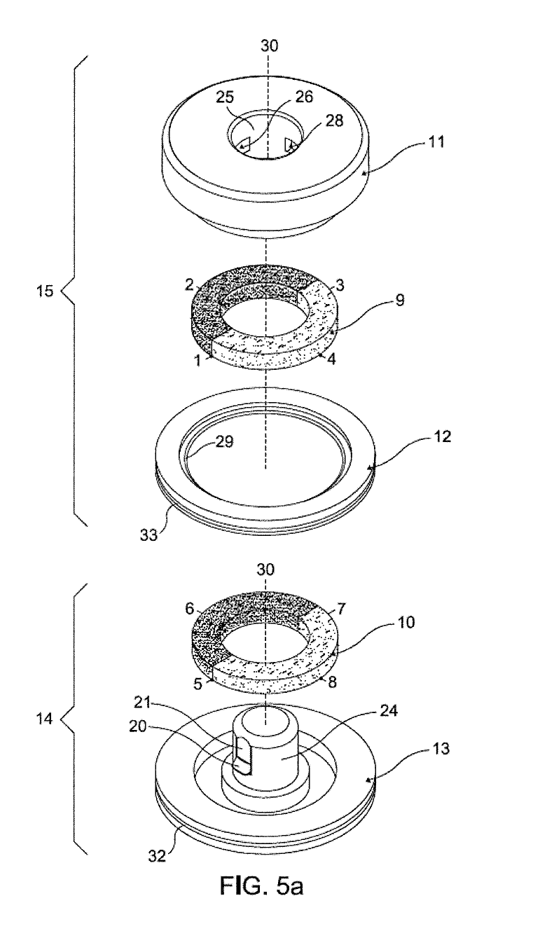

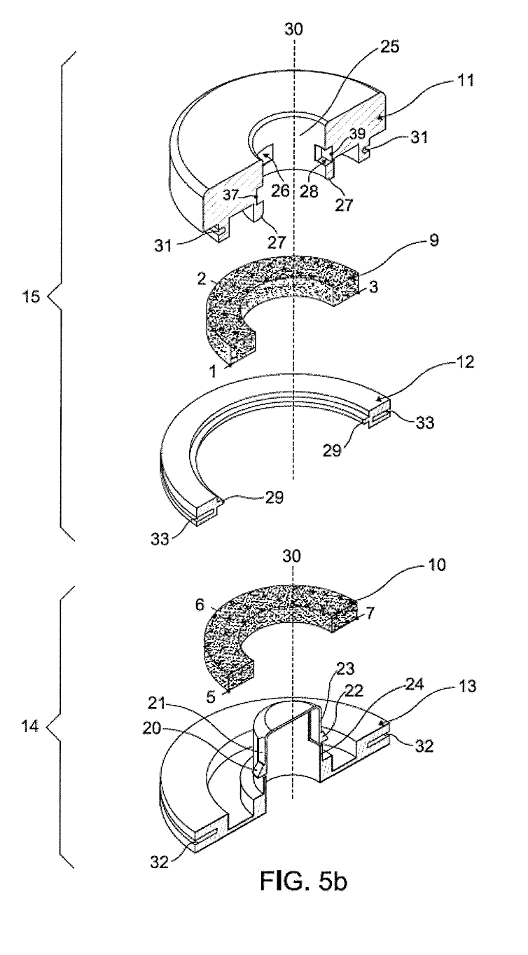

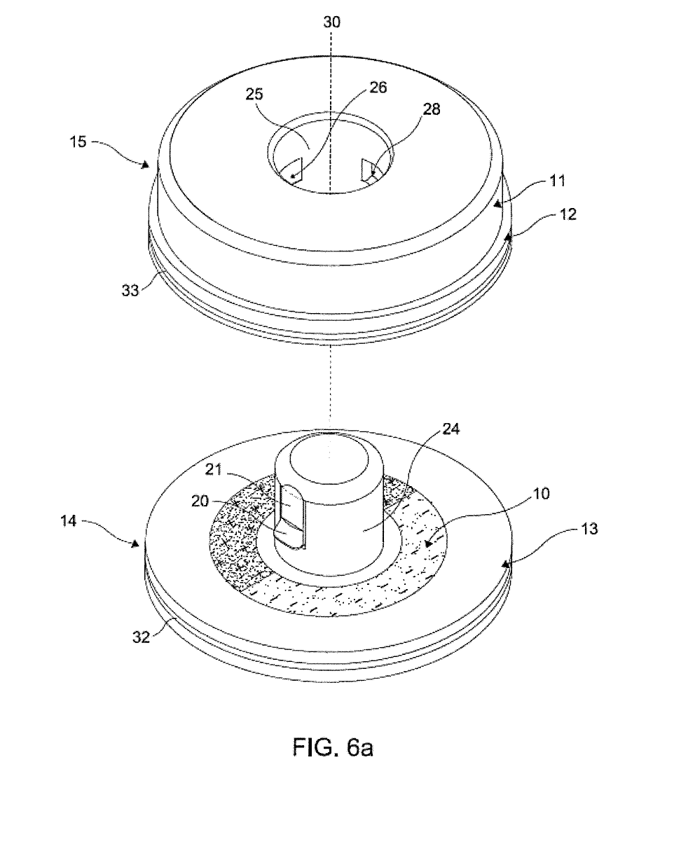

FIG. 5a is an exploded perspective view of an embodiment of the present invention;

FIG. 5b is an exploded sectional view of an embodiment of the present invention;

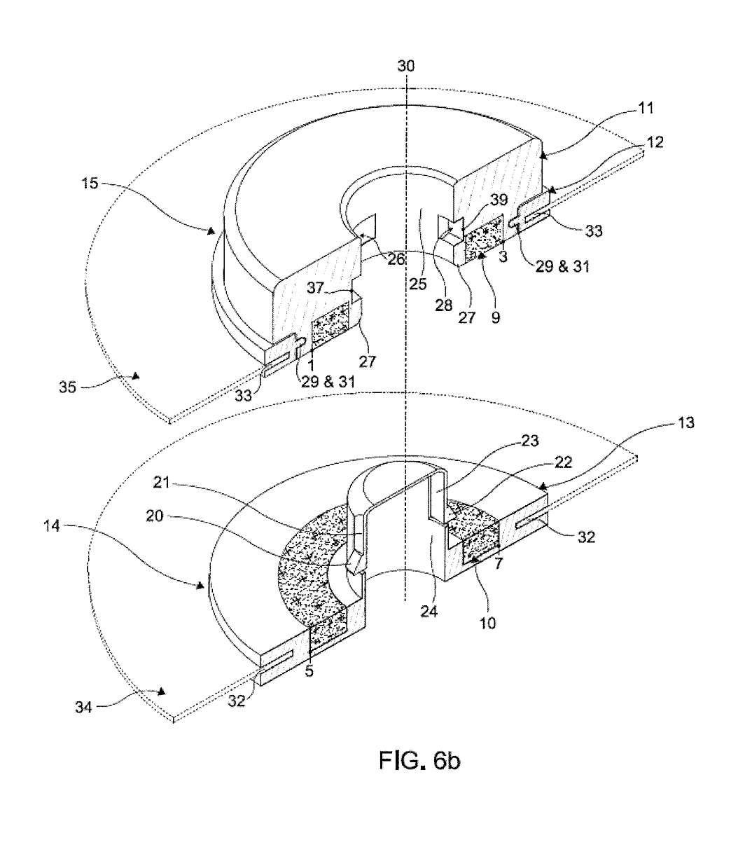

FIG. 6a is a perspective view of the separate male fastening assembly and female fastening assembly of an embodiment of the present invention;

FIG. 6b is a sectional view of the separate male fastening assembly and female fastening assembly of an embodiment of the present invention;

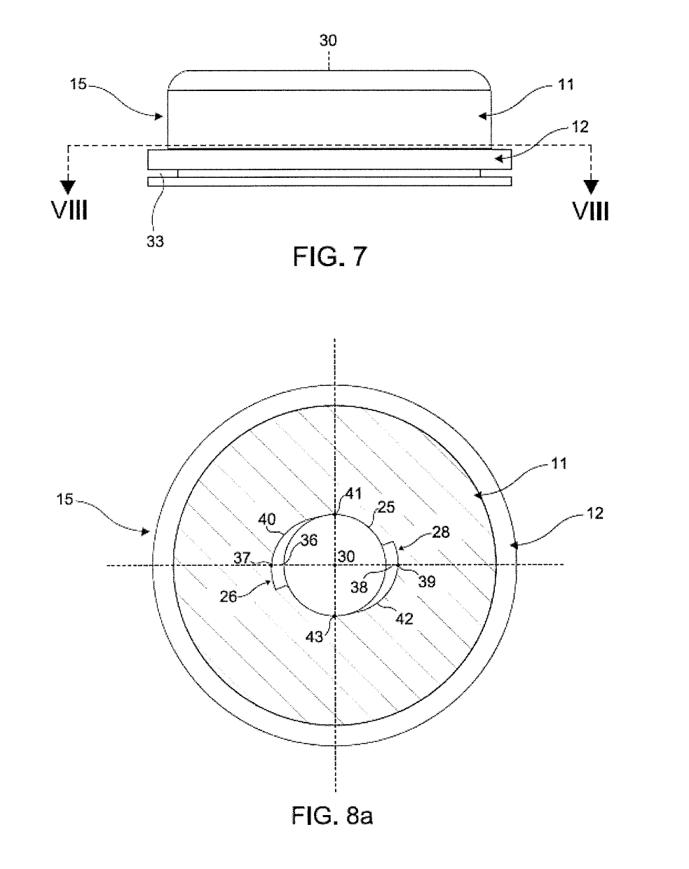

FIG. 7 is a side view of the female fastening assembly of an embodiment of the present invention;

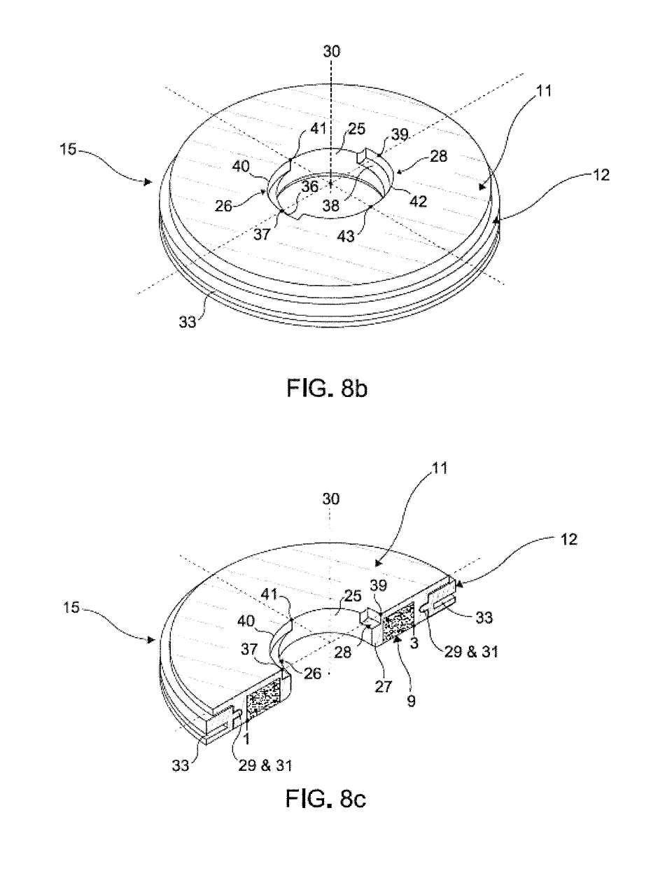

FIG. 8a is a top sectional view of the female fastening assembly of an embodiment of the present invention;

FIG. 8b is a sectional view of the female fastening assembly of an embodiment of the present invention;

FIG. 8c is a sectional view of the female fastening assembly of an embodiment of the present invention;

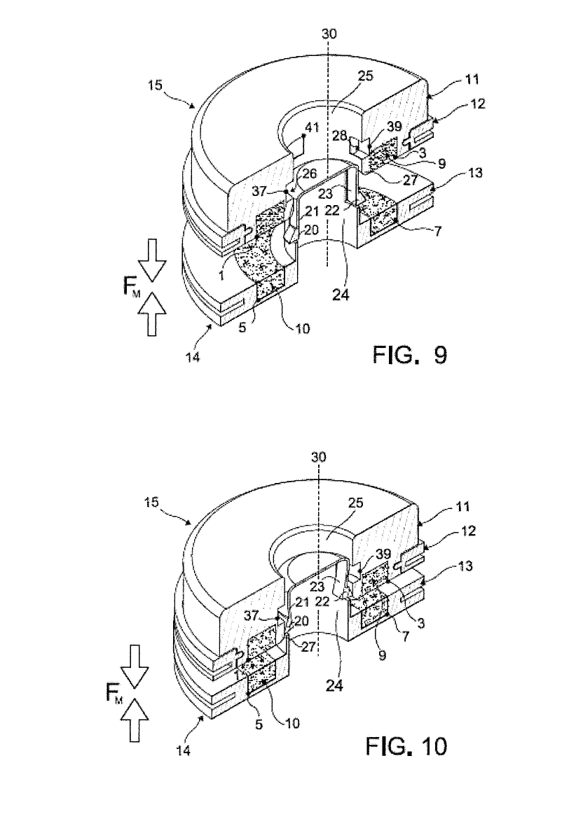

FIG. 9 is a sectional view of the separate fastening assemblies of an embodiment of the present invention;

FIG. 10 is a sectional view of the separate fastening assemblies of an embodiment of the present invention;

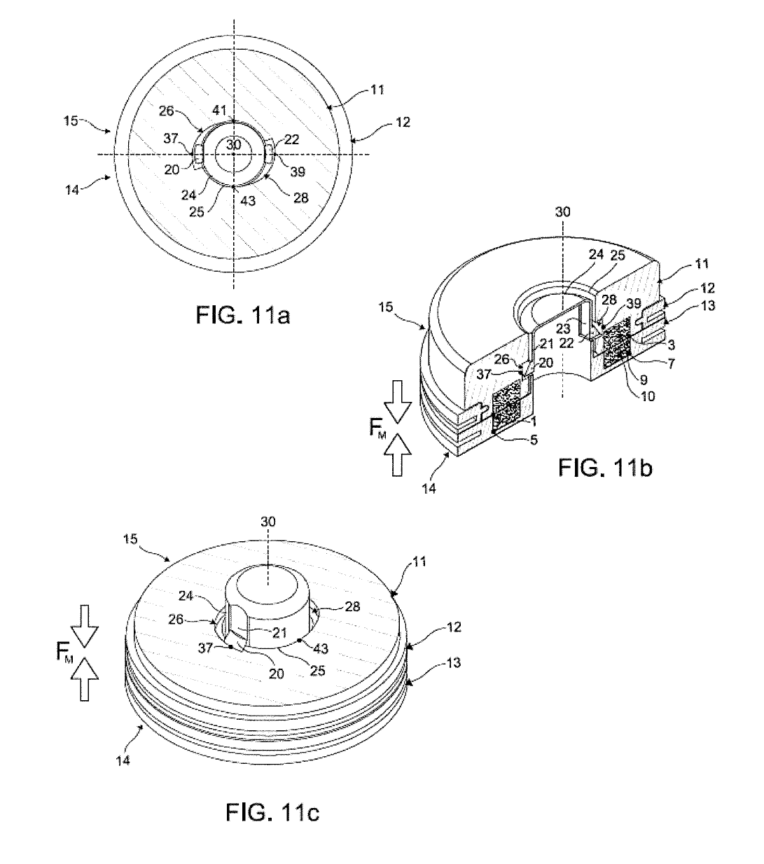

FIG. 11a is a sectional view of the two fastening assemblies in mutual locked condition;

FIG. 11b is a sectional view of the two fastening assemblies in mutual locked condition;

FIG. 11c is a sectional view of the two fastening assemblies in mutual locked condition;

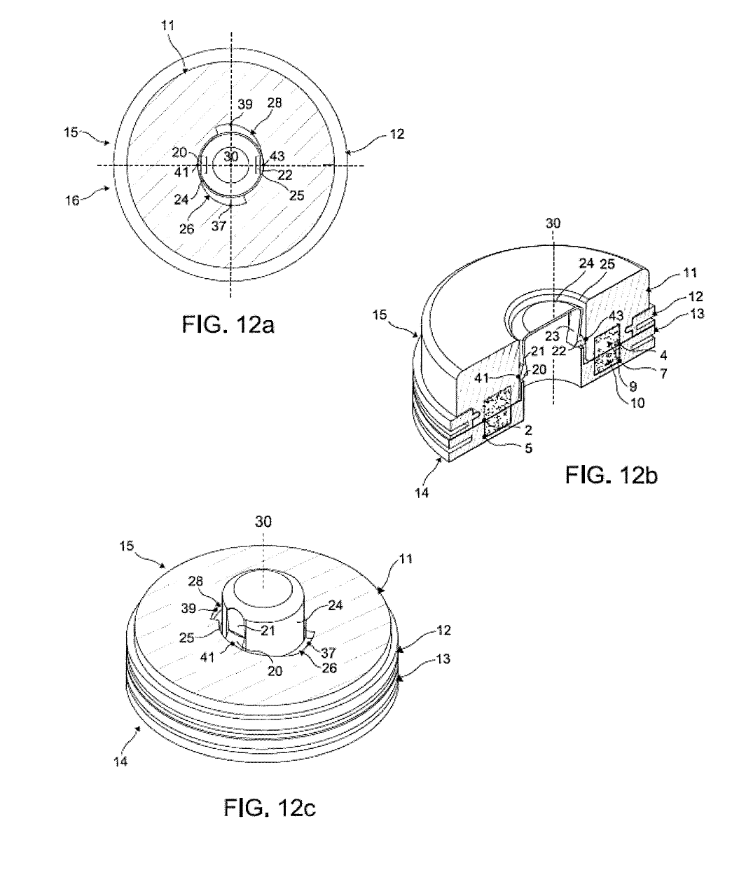

FIG. 12a is a sectional view of the two fastening assemblies in neutral magnetic alignment after a relative 90 degree counter-clockwise manual rotation of the female aperture housing with respect to the fastener's locked condition;

FIG. 12b is a sectional view of the two fastening assemblies in neutral magnetic alignment after a relative 90 degree counter-clockwise manual rotation of the female aperture housing with respect to the fastener's locked condition;

FIG. 12c is a sectional view of the two fastening assemblies in neutral magnetic alignment after a relative 90 degree counter-clockwise manual rotation of the female aperture housing with respect to the fastener's locked condition;

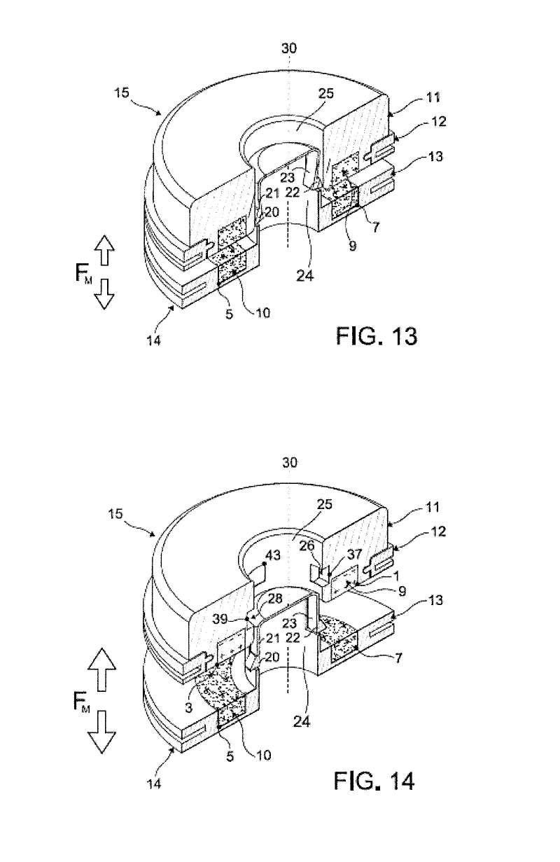

FIG. 13 is a sectional view of the separate fastening assemblies unlocked and separated by the mutual magnetic repulsive forces of the assemblies and their present alignments;

FIG. 14 is a sectional view of the separate fastening assemblies unlocked and separated by the mutual magnetic repulsive forces of the assemblies and their present alignments;

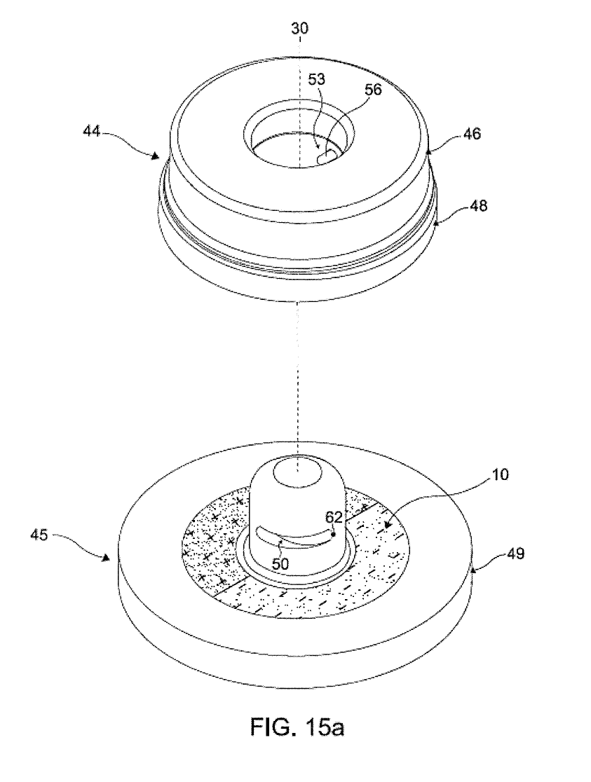

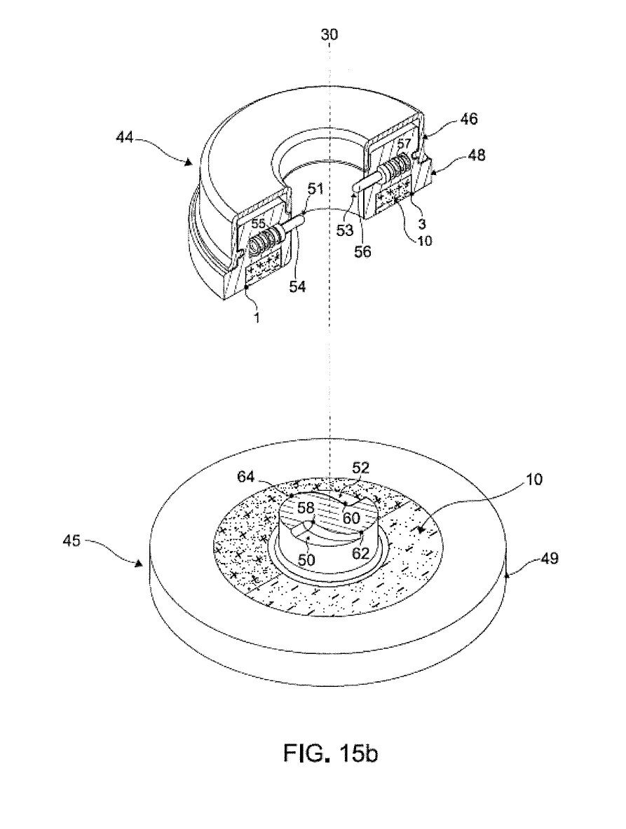

FIG. 15a is a perspective view of the separate male fastener assembly and the female fastener assembly of an embodiment of the present invention;

FIG. 15b is an exploded sectional view of an embodiment of the present invention;

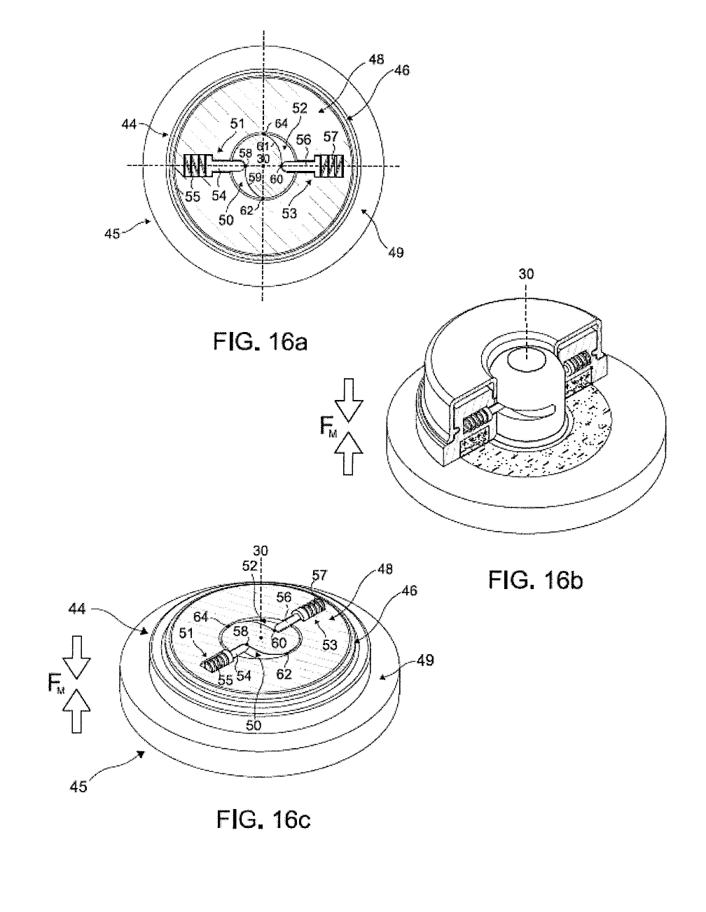

FIG. 16a is a sectional view of the two fastener assemblies in mutual locked condition;

FIG. 16b is a sectional view of the two fastener assemblies in mutual locked condition;

FIG. 16c is a sectional view of the two fastener assemblies in mutual locked condition;

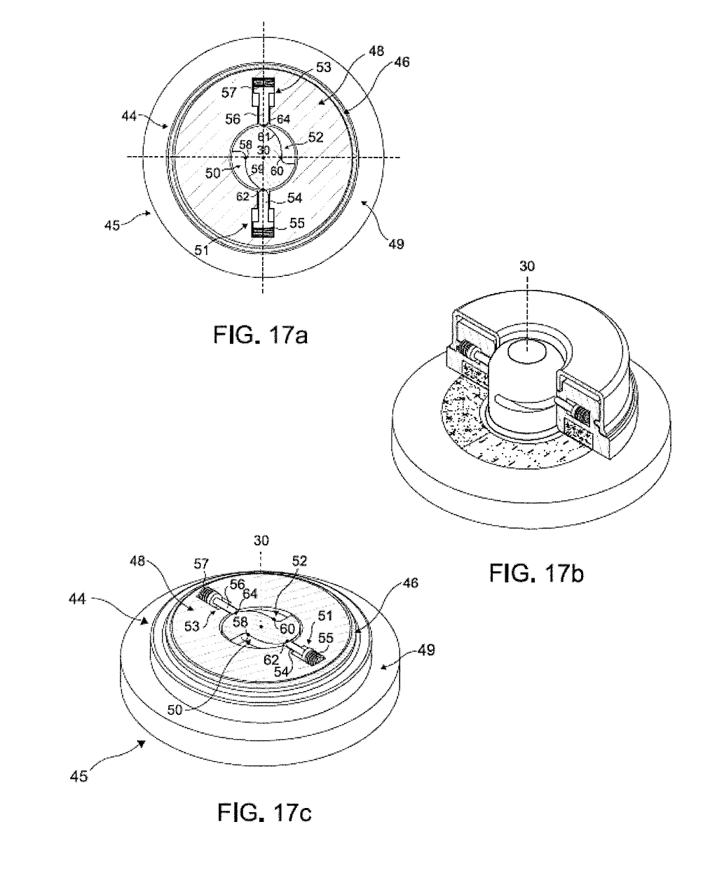

FIG. 17a is a sectional view of the two fastener assemblies in neutral magnetic alignment after a relative 90 degree counter-clockwise manual rotation of female aperture housing with respect to the fastener's locked condition;

FIG. 17b is a sectional view of the two fastener assemblies in neutral magnetic alignment after a relative 90 degree counter-clockwise manual rotation of female aperture housing with respect to the fastener's locked condition;

FIG. 17c is a sectional view of the two fastener assemblies in neutral magnetic alignment after a relative 90 degree counter-clockwise manual rotation of female aperture housing with respect to the fastener's locked condition;

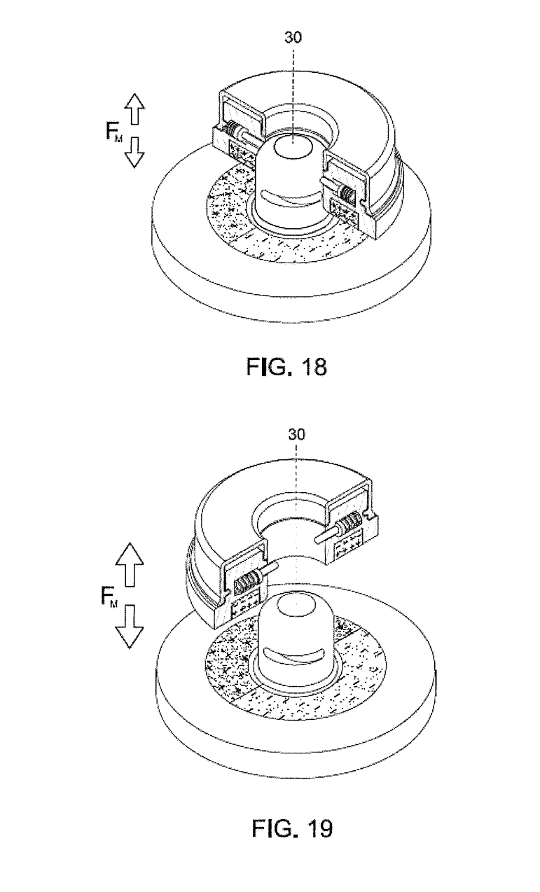

FIG. 18 is a sectional view of the separate fastener assemblies unlocked and separated by the mutual magnetic repulsive forces of the said assemblies in their present alignments;

FIG. 19 is a sectional view of the separate fastener assemblies unlocked and separated by the mutual magnetic repulsive forces of the said assemblies in their present alignments;

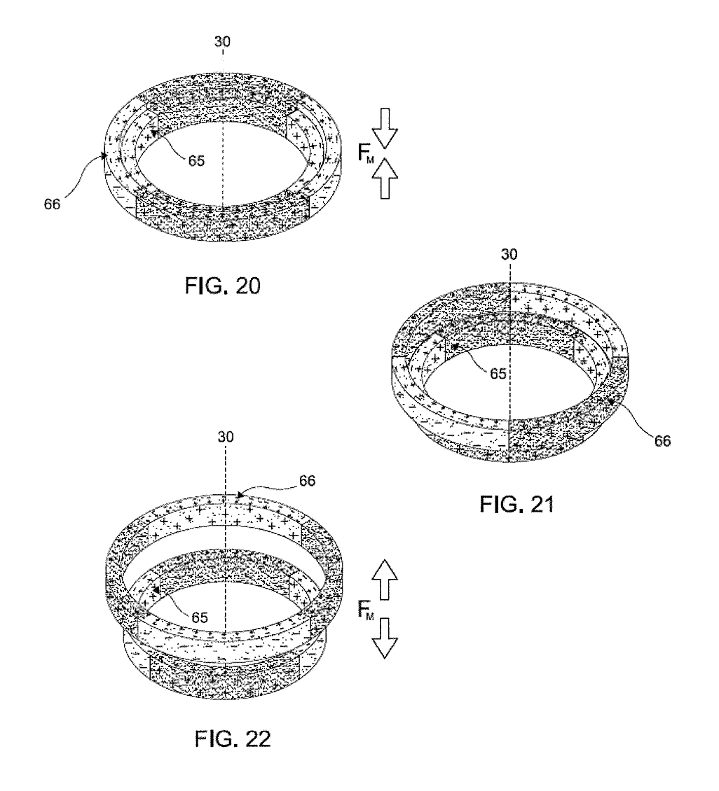

FIG. 20 is a perspective view of the two separate sets of permanent magnets with alternating faced polarities in natural magnetic alignment of an embodiment of the present invention;

FIG. 21 is a perspective view of the two separate sets of permanent magnets with alternating faced polarities after a relative 45 degree counterclockwise rotation of the outer set of permanent magnets with alternating faced polarities of an embodiment of the present invention;

FIG. 22 is a perspective view of the two separate sets of permanent magnets with alternating faced polarities after a relative 90 degree counterclockwise rotation of the outer set of permanent magnets with alternating faced polarities of an embodiment of the present invention;

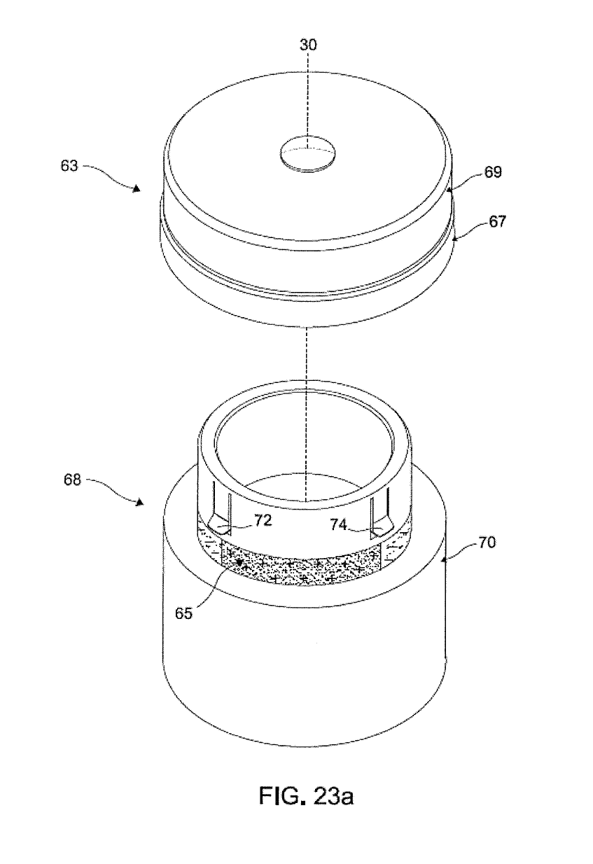

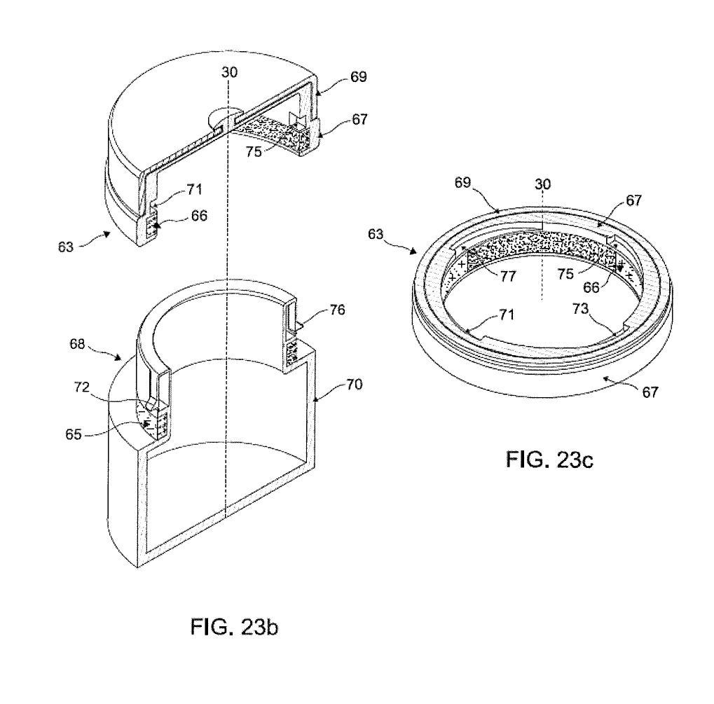

FIG. 23a is a perspective view of the separate closure cover assembly and container assembly of an embodiment of the present invention;

FIG. 23b is a sectional view of the separate closure cover assembly and container assembly of an embodiment of the present invention;

FIG. 23c is a sectional view at mid groove height of the closure cover assembly of an embodiment of the present invention;

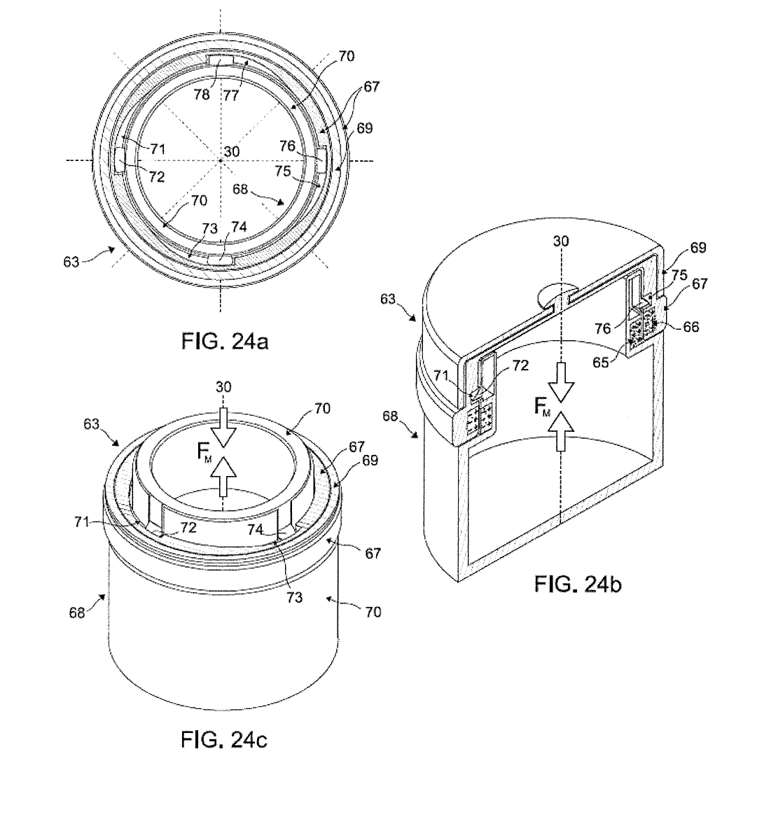

FIG. 24a is a sectional view of the closure container assemblies in locked condition of an embodiment of the present invention;

FIG. 24b is a sectional view of the closure container assemblies in locked condition of an embodiment of the present invention;

FIG. 24c is a sectional view of the closure container assemblies in locked condition of an embodiment of the present invention;

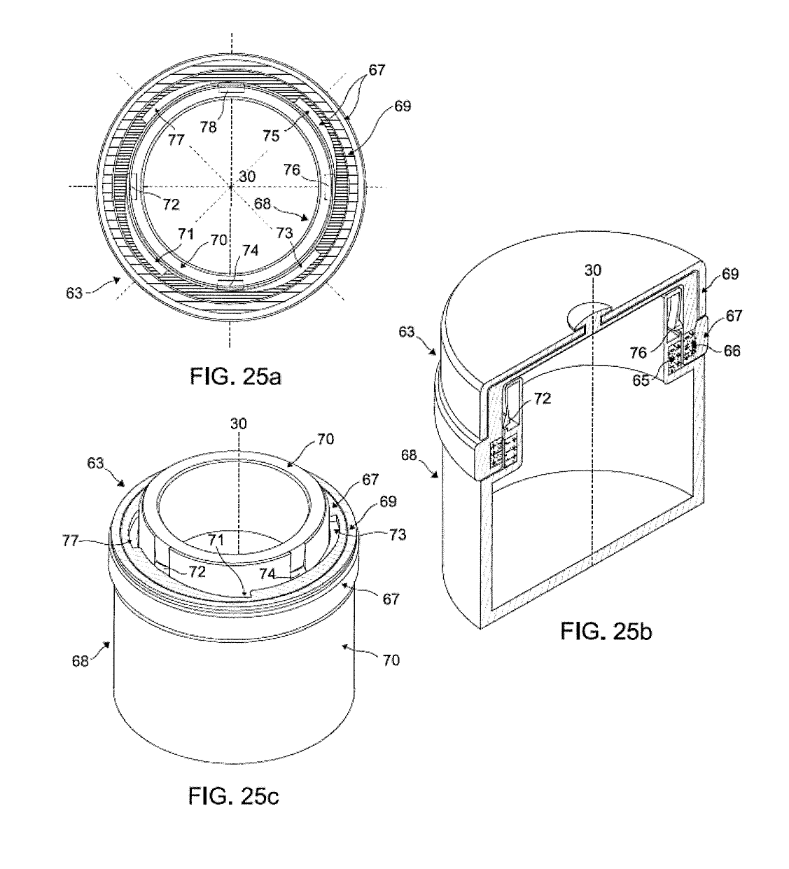

FIG. 25a is a sectional view of the closure container assemblies in unlocked condition after a relative 45 degree counter-clockwise manual rotation of the female aperture housing with respect to the fastener's locked condition;

FIG. 25b is a sectional view of the closure container assemblies in unlocked condition after a relative 45 degree counter-clockwise manual rotation of the female aperture housing with respect to the fastener's locked condition;

FIG. 25c is a sectional view of the closure container assemblies in unlocked condition after a relative 45 degree counter-clockwise manual rotation of the female aperture housing with respect to the fastener's locked condition;

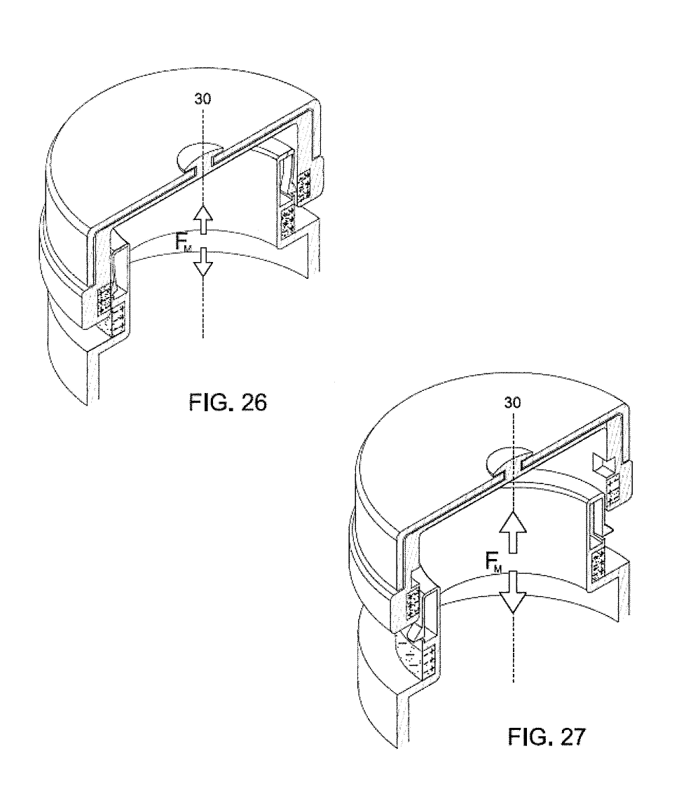

FIG. 26 is a sectional view of the closure container assemblies unlocked and separated by the mutual magnetic repulsive forces of the said assemblies in their present alignments;

FIG. 27 is a sectional view of the closure container assemblies unlocked and separated by the mutual magnetic repulsive forces of the said assemblies in their present alignments;

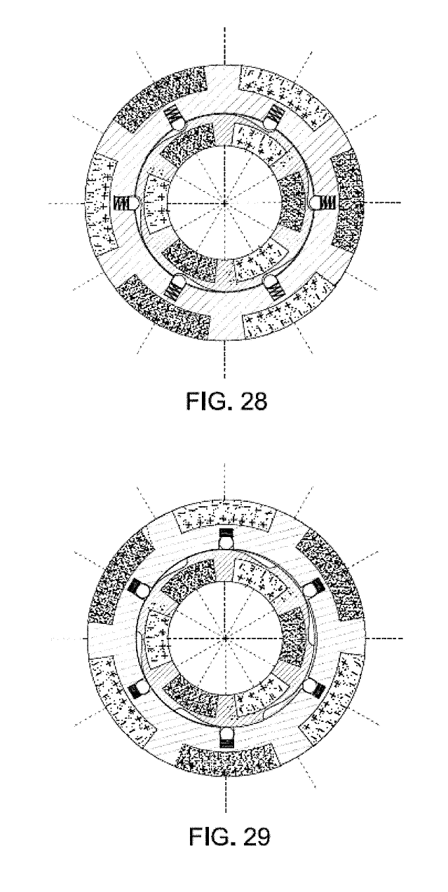

FIG. 28 is a sectional view of an embodiment of the present invention in a locked condition; and

FIG. 29 is a sectional view of an embodiment of the present invention in an unlocked condition.

### DETAILED DESCRIPTION OF THE PREFERRED EMBODIMENTS

In order to understand the internal magnetic workings of the present invention, a review must be conducted of each of the different magnetic alignment forces mutually exerted on the two sets of permanent magnets 9 and 10 as illustrated in FIGS. 1 to 4.

Each set of permanent magnets is comprised of two diametrically opposed identical half-annular magnets with opposed horizontal faced polarities that are permanently connected at their arc ends. The magnets are preferably NdFeB Neodymium magnets or made of other permanent magnetic material or composite.

In the following four illustrations, set of permanent magnets 10 is in an immovable fixed position whereas set of permanent magnets 9 can only be manually revolved around axis 30.

FIG. 1 shows the sets of permanent magnets 9 and 10 in natural magnetic alignment. Both sets of permanent magnets are drawn to each other by a mutual maximum attractive force, thus urging set of permanent magnets 9 to remain in this present alignment. The half-annular magnets from each set of permanent magnets are aligned with their respective attractive counterparts. Half annular magnet 16 is aligned with half annular magnet 18, and a half annular magnet 17 is aligned with half annular magnet 19. This is also shown by the vertical alignment of points 1-5, 2-6, 3-7, 4-9.

With respect to FIG. 1, FIG. 2 shows both sets of permanent magnets after a relative 90 degree counterclockwise manual rotation of set of permanent magnets 9 around axis 30. This is also shown by the vertical alignment of points 2-5, 3-6, 4-7, 1-9.

FIG. 2 shows sets of permanent magnets 9 and 10 in neutral magnetic alignment. There is no mutual magnetic vertical force pulling the permanent sets of magnets towards each other. The sum of the mutually attractive and repulsive vertical magnetic forces of the magnets in this alignment cancel each other out.

With respect to FIG. 1, FIG. 3 shows both sets of permanent magnets after a relative 180 degree manual rotation of set of permanent magnets 9 around vertical axis 30. This is also shown by the vertical alignment of points 3-5, 4-6, 1-7, 2-9.

FIG. 3 shows sets of permanent magnets 9 and 10 aligned in mutual maximum magnetic repulsion from each other. The half-annular magnets from each set of permanent magnets are aligned with their respective repulsive counterparts. Half annular magnet 16 is aligned with half annular magnet 19, and a half annular magnet 17 is aligned with half annular magnet 18.

With respect to FIG. 1, FIG. 4 shows both sets of permanent magnets after a relative 90 degree clockwise manual rotation of set of permanent magnets 9 around vertical axis 30. This is also shown by the vertical alignment of points 4-5, 1-6, 2-7, 3-9.

The sum of the mutual attractive and repulsive magnetic forces of the magnets in this alignment cancel each other out resulting in no vertical force.

FIGS. 5a through 14 show an embodiment of the present invention as a self-actuating magnetic locking fastening device that as an example, can be incorporated on a handbag with a closure flap. The benefit of this embodiment is the low manufacturing costs of the two fastening assemblies.

FIGS. 5a, 5b, 6a and 6b show both the male fastening assembly 14 and female assembly 15 separately with their respective assembly parts.

The male fastening assembly 14 consist of male base unit 13 with set of permanent magnets 10 permanently wedged or fixed were it cannot move.

The male fastening assembly 14 also contains two diametrically opposed protruding sloped flares 20 and 22 having flat surface undersides that extend beyond the outer perimeter wall of cylindrical male projecting member 24. The protruding sloped flares 20 and 22 are incorporated onto flexible flat surface tongues 21 and 23, that are themselves integrated slightly inside the outer perimeter wall of male projecting member 24. The flexion of the flat surface tongues 21 and 23 allow the protruding sloped flares 20 and 22 to fully insert themselves inside the outer perimeter wall of the cylindrical male projecting member 24. This is illustrated further in FIGS. 10, 12a, 12b, 12c and 13.

Materials for the male base unit 13 should preferably be made of a rigid plastic composite material or of a magnetically non conductive metal such as aluminum that can also accept a certain angled flexion of tongues 21 and 23 as described in the previous paragraph.

The bottom edgings of the protruding sloped flares 20 and 22 are rounded and curved in order to allow a seamless rotation of the said protruding sloped flares inside the recessed grooves 26 and 28 integrated in the aperture 25 of female fastening assembly 15.

The protruding sloped flares 20 and 22 are sloped a certain angle in order to re-direct the downwards forces of female lower aperture edging 27 pushing on the protruding sloped flares 20 and 22 into flexion of tongues 21 and 23, thus allowing the said protruding sloped flares 20 and 22 to insert themselves fully inside the outer perimeter wall of male projecting member 24.

The male projecting member 24 has the top part that is rounded in order to allow a more seamless insertion of itself into female aperture housing 25 of the female fastening assembly 15.

As an example, the male fastening assembly 14 is permanently attached to the front section of the handbag that will receive the closure flap. The male fastening assembly 14 is attached by permanently hinging, gluing or mechanically fastening the handbag fabric material 34 inside insert 32 as shown in FIG. 6b.

The female fastening assembly 15 consists of female aperture housing 11, set of permanent magnets 9 and interconnected outer axial ring 12. The female aperture housing 11 and interconnected outer axial ring 12 are preferably made of a rigid plastic composite material or of a magnetically non conductive metal such as aluminum. Set of permanent magnets 9 is permanently wedged or fixed into revolving housing 11 where it cannot move.

The interconnected axial outer ring 12 is interconnected with female aperture housing 11 by the protruding circular ring member 29 that is interlocked with the circular concave ring opening 31 included in female aperture housing 11. This allows female aperture housing 11 and interconnected axial outer ring 12 to have relative independent unrestrained rotational movements around the same center axis 30.

As an example, the female fastening assembly 15 is permanently attached to the front section of the closure flap of the handbag by permanently hinging, gluing or mechanically fastening the closure flap material fabric 35 inside insert 33 as shown in FIG. 6b.

As a result of both fastening assemblies permanently connected to their respective parts of the handbag with closure flap, only female aperture housing 11 containing set of permanent magnets 9 can revolve freely. The edgings of the top portion of female aperture housing 11 are rounded as female aperture housing 11 is manually operated.

In the drawings, male fastening assembly 14 and interconnected axial outer ring 12 are fixed and cannot revolve, only female aperture housing 11 can revolve freely.

The lower aperture edging 27 of female aperture housing 11 is rounded for a more seamless insertion of the male projecting member 24 into said female aperture housing 11. The lower aperture edging 27 of female aperture housing 11 is further rounded as the said aperture edging 27 will also press on the protruding sloped flares 20 and 22, generating a force that will result in the flexion of tongues 21 and 23, thus allowing the protruding sloped flares 20 and 22 to insert themselves inside the outer perimeter wall of male projecting member 24.

FIGS. 8a, 8b and 8c are sectional views of the female fastening assembly 15 on cross section VIII-VIII of FIG. 7.

FIG. 8a shows the recessed grooves 26 and 28 diametrically opposed that begin with recessed openings 36 and 38 that are inverted shapes of the protruding sloped flares 20 and 22. The said recessed openings 36 and 38 allow the full insertion of the protruding flares 20 and 22 in locked condition and are of slightly larger shape than of said protruding sloped flares 20 and 22 in order to accept any minor axial misalignment of the mutually locked fastening assemblies 14 and 15 caused by physical factors such as friction and minor off-centering.

Starting from respective center middle points 37 and 39 situated on the recessed openings 36 and 38 inner walls, the recessed inner wall depths of grooves 26 and 28 diminish in a clockwise direction in the form of a spiral arcs 40 and 42 centered on axe 30, ending with respective points 41 and 43 wherein the said spiral arcs 40 and 42 radii are equal to the radius of the female inner aperture wall 25 which is also centered on axe 30. The angular lengths of the spiral arc grooves 40 and 42 are 90 degrees starting from points 37 and 39 to respective points 41 and 43.

The inner recessed walls of the recessed grooves 26 and 28 are straight and of further slightly greater height than the protruding sloped flares 20 and 22 in order to allow the flexion movements of the said protruding sloped flares inside the said grooves. The edgings of the recessed grooves 26 and 28 are rounded to allow a seamless insertion of the protruding sloped flares 20 and 22 inside the said grooves.

The recessed grooves 26 and 28 allow a seamless 90 degree counterclockwise rotational transition of the protruding sloped flares 20 and 22 from their natural protruding positions in locked condition to their inserted position inside the outer perimeter wall of male projecting member 24. However, the recessed grooves 26 and 28 will also impede a clockwise rotation of the flares from locked condition.

FIGS. 11a, 11b and 11c show the fastening assemblies 14 and 15 in their locked condition. The protruding sloped flares 20 and 22 fully extend into the respective recessed openings 36 and 38 of the respective grooves 26 and 28; and are centrally aligned with respective middle center points 37 and 39. This locked condition will obstruct external vertical pulling separating forces exerted on the fastening assemblies from being separated.

Subsequently, it is in this locked condition that the sets of permanent magnets 9 and 10 are also in their natural magnetic alignment positions. The permanent positioning of sets of permanent magnets 9 and 10 in their respective fastening assemblies 14 and 15 coincide with the magnetic attractive alignment of the sets of permanent magnets 9 and 10 shown in FIG. 1 and the locked condition of the fastener assemblies 14 and 15 shown in FIGS. 11a, 11b, 11c.

In this manner, the mutual magnetic attractive forces of the sets of permanent magnets 9 and 10 will also urge the fastening assemblies 14 and 15 to remain aligned in locked condition.

If external separation forces greater than the mutual magnetic attractive forces of the said permanent sets of magnets, are exerted on the fastening assemblies 14 and 15, the locked condition of the protruding sloped flares 20 and 22 fully extended into the respective recessed openings 36 and 38, will obstruct the separation of the said fastening assemblies.

As the separate male and female fastening assemblies 14 and 15 are drawn near each other, a radial magnetic force will cause female aperture housing 11 to axially revolve into natural magnetic attractive alignment with set of permanent magnets 10 contained in the male fastening assembly 14.

The vertical attractive forces between the two sets of permanent magnets will increase as set of permanent magnets 9 revolves towards natural magnetic alignment with set of permanent magnets 10. This will result in the projecting male member being drawn into the aperture of the female assembly as shown in FIG. 9.

As the male projecting member 24 is magnetically drawn into the female aperture 25, the lower aperture edging 27 will push on the flare 20 and 22 slopes, thus inserting the said flares inside the outer perimeter wall of the said male projecting member 24. This will then allow the projecting member to insert itself completely, without obstruction as shown in FIG. 10.

The magnetic alignment forces revolving the female aperture housing 11 will also position the recessed grooves 26 and 28 into locked condition, thus releasing the protruding sloped flares 20 and 22 to their natural protruding position inside the recessed openings 36 and 38 as shown in FIGS. 11a, 11b and 11c.

This can be related to the example of the present embodiment incorporated on a handbag with a closure flap wherein the outer flap of the handbag containing female assembly 15 is magnetically drawn to the front section of the purse containing male assembly 14 by the self-actuating rotation of the female aperture housing 11 into magnetic alignment, thus automatically locking itself where the outer flap of the handbag can longer be pulled open.

As male assembly 14 and interconnected axial outer ring 12 are fixed and cannot revolve, FIGS. 12a, 12b and 12c show the fastening assemblies after a relative manual 90 degree counter-clockwise rotation of female aperture housing assembly 11 with respect to the naturally locked position of the fastener.

As set of permanent magnets 9 has also revolved 90 degrees along with female aperture housing 11, FIGS. 12a, 12b and 12c are also concordant with the neutral magnetic alignment of FIG. 2. As described earlier, this neutral magnetic alignment results with no magnetic vertical forces pulling the assemblies towards each other.

Equally, the 90 degree rotation of recessed grooves 26 and 28 has resulted with the inner aperture wall 25 of the female aperture housing now pushing the protruding sloped flares 20 and 22 inside the outer perimeter wall of the male projecting member 24, thus allowing vertical movement of the female aperture housing.

The fastening assemblies 14 and 15 are now in an unlocked alignment where said female assembly 15 may be released by an applied vertical manual separation force.

FIG. 13 shows the fastening assemblies after a relative manual counter-clockwise rotation of female aperture housing 11 anywhere between 90 and 180 degrees, with respect to the naturally locked position of the fastener.

As set of permanent magnets 9 has also revolved more than 90 degrees along with female aperture housing 11, the sets of permanent magnets 9 and 10 are now in magnetic repulsion from each other. The vertical magnetic repulsion forces of the magnets increase as assembly 9 revolves towards 180 degrees.

This will result in the full separation of the fastening assemblies actuated by the magnetic repulsion forces of the magnets.

FIG. 14 illustrate the female fastening assembly 15 separated and magnetically repelled from the male assembly 14 after a relative manual counter-clockwise rotation of only the female aperture housing 11 180 degrees. As assembly 9 has also revolved 180 degrees along with female aperture housing 11, FIG. 14 is also concordant with the maximum magnetic repulsion alignment of FIG. 3.

This can be related to the example of the present embodiment incorporated on a handbag with a closure flap wherein the manual rotation of female aperture housing 11 about 180 degrees will result in the unlocking and repelling of the closure flap away from the said handbag.

FIGS. 15a through 25 show a further embodiment of the present invention as an independent self-actuating magnetic locking fastener that can be applied for example, as a paper fastener for papers with perforated holes.

In the present embodiment drawings, male fastener assembly 45 and interconnected outer axial ring cover 46 are manually held and cannot revolve, only female aperture housing 48 can revolve freely.

FIGS. 15a and 15b show both the male fastener assembly 45 and female fastener assembly 44 separately with their respective assembly parts. The sets of permanent magnets 9 and 10 are permanently positioned in their respective assemblies.

In this embodiment, the male fastener assembly 45 contains the recessed grooves 50 and 52 of the present invention. Consequently, the retractable protruding pins 51 and 53 are integrated in the female fastener assembly 44.

The female fastener assembly 44 also contains independently revolving female aperture housing 48 and interconnected outer axial ring cover 46 that have independent unrestrained rotational movements around axis 30.

As the female interconnected outer axial ring cover 46 and male fastener assembly 45 are manually held and drawn towards each other, a radial magnetic force will cause female aperture housing 48 to relatively revolve into natural magnetic attractive alignment with set of permanent magnets 10 contained in male fastener assembly 45. The mutual vertical attractive forces between the two assemblies 44 and 45 will increase as set of permanent magnets 9 revolves towards natural magnetic alignment with set of permanent magnets 10. This will result in the projecting member of said male fastener assembly 45 being drawn into the female aperture housing 48 of said female assembly 44, thus enabling the retractable protruding pins 51 and 53 of said female assembly 44 to interlock with the recessed grooves 50 and 52 of said male assembly 45. This locked condition is illustrated in FIGS. 16a, 16b and 16c.

The retractable protruding pins 51 and 53 contained in the female aperture housing consists of springs 55 and 57 that enables cylindrical rounded pins 54 and 56 to fully retract inside the inner perimeter walls of the female aperture housing 48. This unlocked position is illustrated further in FIGS. 17a, 17b and 17c.

The springs 55 and 57 and cylindrical rounded pins 54 and 56 should preferably be made of a rigid plastic composite material or of a magnetically non conductive metal such as aluminum. As the projecting member of male fastener assembly 45 is inserted into female aperture housing 48, the rounded top portion of the said male projection member pushes the cylindrical rounded pins 54 and 56 into a horizontal retracting movement. This is illustrated further in FIG. 18.

The recessed grooves 50 and 52 integrated in the outer perimeter wall of the projecting member of male assembly 45 are similar to those of the first embodiment where:

FIGS. 16a and 17a show that the recessed grooves 50 and 52 are diametrically opposed and begin with recessed openings in order to allow the full insertion of the protruding cylindrical rounded pins 54 and 56 in locked position as illustrated in FIGS. 16a, 16b and 16c. The dimensions of the said openings are slightly larger than of the protruding cylindrical rounded pins 54 and 56 in order to accept any minor axial misalignment of the locked fastener assemblies 44 and 45 caused by physical factors such as friction and minor off-centering.

However, as the interlocking assembly parts have been inverted between fastener assemblies in contrast to the first embodiment, the direction of the second embodiment's recessed grooves 50 and 52 are now counter-clockwise.

Starting from respective center middle points 58 and 60 situated on the recessed openings inner walls, the recessed inner wall depths of grooves 26 and 28 diminish in a counter-clockwise direction in the form of a spiral arcs 59 and 61 centered on axe 30, ending with respective points 62 and 64 wherein the said spiral arcs 59 and 61 radii are equal to the radius of the outer perimeter wall of the male projecting member which is also centered on axe 30. The angular lengths of the spiral arc grooves 40 and 42 are 90 degrees starting from points 58 and 60 to respective points 62 and 64.

The inner recessed walls of the recessed grooves 50 and 52 are rounded concavely and slightly larger than the rounded ends of the rounded cylindrical pins 54 and 56. This will allow a seamless unrestricted 90 degree counterclockwise rotational transition of the said rounded cylindrical pins 54 and 56 from their natural protruding position aligned with points 58-60 to their respectively retracted position aligned with points 62-64 inside the inner perimeter wall of the female aperture. The recessed grooves 50 and 52 will also obstruct a clockwise rotation of the of the said rounded cylindrical pins 54 and 56.

FIGS. 16a, 16b and 16c show the fastener assemblies in their locked condition. Both protruding cylindrical pins 54 and 56 are inside the recessed openings of the grooves 66 and 52. This locked condition will obstruct the vertical movements of the fastener assemblies exerted by external vertical separation forces.

FIGS. 17a, 17b and 17c show the fastener assemblies after a relative 90 degree manual counter-clockwise rotation of only female aperture housing 48 with respect to the naturally locked position of the fastener.

As described earlier, this neutral magnetic alignment will result with no magnetic vertical forces attracting the assemblies towards each other. Equally, the 90 degree counter-clockwise rotation of the female aperture housing has resulted in the complete retraction of the protruding pins 54 and 56 from the respective grooves 50 and 52, thus allowing vertical movement of the female aperture housing.

The fastening assemblies 44 and 45 are now in an unlocked alignment where the said female assembly 15 may be released by an applied vertical manual separation force.

FIG. 18 shows the fastener assemblies after a relative manual counter-clockwise rotation of female aperture housing 48 anywhere between 90 and 180 degrees with respect to the naturally locked position of the fastener.

This will result in the full separation of the fastener assemblies actuated by the magnetic repulsion forces of the magnets.

FIG. 19 illustrate the female fastening assembly 44 separated and magnetically repelled from the male fastener assembly 45 after a relative manual counter-clockwise rotation of only the female aperture housing 48 180 degrees. As set of permanent magnets 9 has also revolved 180 degrees along with female aperture housing 11, FIG. 19 is also concordant with the maximum magnetic repulsion alignment of FIG. 3.

In order to understand the internal magnetic workings of a further embodiment of the present invention, we must first review the different magnetic alignment forces exerted on the two sets of permanent magnets 65 and 66 that possess alternating faced polarities, as illustrated in FIGS. 20 to 22.

Each of the sets of permanent magnets 65 and 66 is now comprised of two identical pairs of diametrically opposed arched magnets with alternating radial faced magnetic polarities, all permanently connected at their arc ends. As the sets of permanent magnets 65 and 66 are of equal height, set of permanent magnets 66, being exterior, is positioned slightly higher than set of permanent magnets 65, being interior.

In the following three illustrations, set of permanent magnets 65 is in an immovable fixed position wherein set of permanent magnets 66 can be manually revolved around axis 30 and can also be manually pulled upwards from its held vertical position illustrated in FIG. 20.

The magnets are preferably NdFeB Neodymium Magnets or of other permanent magnetic material or composite.

FIG. 20 shows the two sets of permanent magnets 65 and 66 in natural magnetic alignment by mutual maximum attractive magnetic forces, thus urging set of permanent magnets 66 to remain in this present alignment. The pairs of arched magnets from each set of permanent magnets are aligned with their respective magnetically attractive counterparts.

This natural magnetic alignment can be repeated by a relative rotation of set of permanent magnets 66 180 degrees around axis 30 with respect to the natural magnetic alignment of FIG. 20. Hence, the magnetic configuration of sets of permanent magnets 65 and 66 allow two natural magnetic alignment positions that are diametrically opposed.

With respect to FIG. 20, FIG. 21 shows both sets of permanent magnets 65 and 66 after a relative 45 degree counter-clockwise manual rotation of set of permanent magnets 66 around axis 30, completed with a vertical separation movement.

FIG. 21 shows sets of permanent magnets 65 and 66 in neutral magnetic alignment. There is no mutual vertical force pulling the sets of permanent magnets towards each other. The sum of the attractive and repulsive vertical magnetic forces of the magnets in this alignment cancel each other out. However, a clockwise magnetic radial force resulting in a vertical force urges set of permanent magnets 66 to re-align itself to the natural alignment of FIG. 20. This neutral magnetic alignment can be repeated every 90 degree rotation starting from a natural magnetic alignment.

With respect to FIG. 20, FIG. 22 shows both sets of permanent magnets 65 and 66 after a relative 90 degree manual rotation of set of permanent magnets 66 around vertical axis 30.

FIG. 22 shows sets of permanent magnets 65 and 66 aligned in mutual maximum magnetic repulsion from each other. The magnets from each set of permanent magnets 65 and 66 are aligned with their respective magnetic repulsive counterparts.

This maximum magnetic repulsion alignment can be repeated by a relative rotation of set of permanent magnets 66 180 degrees around axis 30 with respect to FIG. 22. Hence, the magnetic configuration of sets of permanent magnets 65 and 66 allow two maximum magnetic repulsion alignment positions that are diametrically opposed.

In order to obtain an upward separation of set of permanent magnets 66 with respect to set of permanent magnets 65, set of permanent magnets 66 must be more elevated than set of permanent magnets 65 in order to obtain an upward repulsive force cause by the present alignment of the magnetic fields.

FIGS. 23a through 27 show the further embodiment of the present invention applied as a magnetic self-actuating locking closure container.

FIGS. 23a, 23b and 23c show the female closure cover assembly 63 and male container assembly 68 separately with their respective assembly parts.

Given that female closure cover assembly 63 and male container assembly 68 of this further embodiment now each contain two sets of diametrically opposed permanent magnets arranged in a symmetrical polar array of alternating faced polarities, two sets of diametrically opposed protruding flares and grooves are also contained in the third embodiment as illustrated in recessed grooves 71, 73, 75 and 77 and flexible protruding sloped flares 72, 74, 76 and 78.

The sets of permanent magnets 65 and 66 are permanently positioned in their respective assemblies in concordance with their said natural magnetic attractive alignments shown in FIG. 20 and the locked condition of the closure container shown in FIGS. 24a, 24b and 24c.

The flexible protruding sloped flares 72, 74, 76 and 78 are constructed in the same manner as the first embodiment of the present invention.

The recessed grooves 71, 73, 75 and 77 are similar to the first embodiment with the exception that each spiral arc length is now 45 degrees in order to allow a seamless 45 degree counterclockwise rotational transition of the flexible protruding sloped flares 72, 74, 76 and 78 from their natural protruding positions in said locked condition to their flexed inserted condition which is concordant with the neutral magnetic alignment of the sets of permanent magnets 65 and 66 illustrated in FIG. 21. FIGS. 25a, 25b and 25c show the closure container assemblies 63 and 68 after a relative 45 degree manual counter-clockwise rotation of female aperture housing cover 67 with respect to said closure container assemblies 63 and 68 in locked condition.

The closure container is now in an unlocked alignment where female closure cover assembly 63 may be separated by an applied vertical manual separation force.

FIG. 26 shows the closure container assemblies 63 and 68 after a relative manual counter-clockwise rotation of female aperture housing cover 67 anywhere between 45 and 90 degrees, with respect to the closure container in locked condition.

The mutual vertical magnetic repulsion forces of the magnets increase as assembly 66 revolves towards 90 degrees. This will result in the unlocking and repelling of the female closure cover assembly 63 away from male container assembly 68.

FIG. 27 shows the female cover assembly 63 separated and magnetically repelled from the male container assembly 68 after a relative manual counter-clockwise rotation of female aperture housing cover 67 90 degrees. As set of permanent magnets 66 has also revolved 90 degrees along with said female aperture housing cover 67, FIG. 27 is also concordant with the mutual maximum magnetic repulsion alignment of FIG. 22.

FIG. 28 is a sectional view of an embodiment of the present invention in a locked condition and FIG. 29 is a sectional view of an embodiment of the present invention in an unlocked condition.

I claim:

1. A self-actuating magnetic locking system consisting of a manually separable male assembly and a manually separable female assembly wherein:
(a) the female assembly includes an inner cylindrical aperture housing;
(b) the male assembly includes a cylindrical projecting male member that can be inserted into and be relatively rotatable with respect to the inner cylindrical aperture housing of the female assembly, engendering a locked condition;
(c) the male assembly and the female assembly each consisting of an at least one set of diametrically opposed permanent magnets arranged in a symmetrical polar array of alternating faced polarities; and
(d) the male assembly and the female assembly consisting of an equal quantity of at least one set of permanent magnets;
whereby the at least one set of permanent magnets being respectively shaped and positioned in the male assembly and the female assembly so as to magnetically draw the cylindrical projecting male member and the female aperture into a mutual locked condition when said assemblies are brought into proximity of each other.

2. The self-actuating magnetic locking system of claim 1 wherein the male assembly consists of at least one set of diametrically opposed protruding elements that naturally extend in a radial manner beyond the outer perimeter wall of the cylindrical projecting male member.

3. The self-actuating magnetic locking system of claim 1 wherein the female assembly consists of at least one set of diametrically opposed recessed grooves integrated in the inner cylindrical aperture housing wall of the female assembly.

4. The self-actuating magnetic locking system of claim 3 wherein the at least one set of diametrically opposed recessed grooves begin with a recessed opening inside the female aperture housing wall to allow the protruding elements to fully extend in a radial manner beyond an outer perimeter wall of the cylindrical projecting male member and into the recessed opening of an inner perimeter wall of the female aperture in a locked condition.

5. The self-actuating magnetic locking system of claim 4 wherein from a middle center of the recessed opening inner wall, a depth of the recessed wall decreases in a counter-clockwise direction, in a form of a spiral arc centered on a same central axis of the female cylindrical aperture housing wall, ending with the spiral arc radius equal to the radius of said female cylindrical aperture housing wall.

6. The self-actuating magnetic locking system of claim 2 wherein the least one set of diametrically opposed protruding elements are integrated with a spring or flexion system that allows the said protruding elements to fully retract inside the outer perimeter wall of the cylindrical projecting male member.

7. The self-actuating magnetic locking system of claim 2 wherein the least one set of diametrically opposed protruding elements are shaped to allow a seamless retraction of themselves by a force of a rounded edging of the inner cylindrical female aperture housing pushing onto the protruding elements when the cylindrical projecting male member is inserted into the inner cylindrical aperture housing of the female assembly.

8. The self-actuating magnetic locking system of claim 1 wherein in the locked condition the projecting male member is magnetically drawn into the inner cylindrical aperture housing of the female assembly and is rotationally aligned where the protruding elements are fully extended in a radial manner beyond the said outer perimeter wall of the cylindrical projecting male member and into the recessed groove openings of the said inner perimeter wall of the female aperture.

9. The self-actuating magnetic locking system of claim 1 wherein the protruding elements are further shaped to allow a seamless rotation of themselves inside the recessed grooves.

10. The self-actuating magnetic locking system of claim 1 wherein the at least one set of diametrically opposed recessed grooves allow a relative counter-clockwise rotation of the protruding elements inside the grooves engendering the transition of the protruding elements from their natural protruding positions in locked condition to their retracted position inside the said outer perimeter wall of the cylindrical projecting male member in unlocked condition.

11. The self-actuating magnetic locking system of claim 1 wherein the female assembly consists of at least one set of diametrically opposed protruding elements that naturally extend in a radial manner beyond the inner cylindrical aperture housing wall of the female assembly.

12. The self-actuating magnetic locking system of claim 1 wherein the male assembly consisting of at least one set of diametrically opposed recessed grooves integrated in the cylindrical projecting male member wall.

13. The self-actuating magnetic locking system of claim 12 wherein the at least one set of diametrically opposed recessed grooves begin with a recessed opening inside the cylindrical projecting male member wall to allow the protruding elements to fully extend in a radial manner beyond the inner perimeter wall of the female aperture and into the recessed groove opening of the said cylindrical projecting male member wall in a locked condition.

14. The self-actuating magnetic locking system of claim 13 wherein from a middle center of said recessed opening inner wall, a depth of the recessed wall decreases in a counter-clockwise direction, in a form of a spiral arc centered on the same central axis of the cylindrical projecting male member wall, ending with the spiral arc radius equal to the radius of said cylindrical projecting male member wall.

15. The self-actuating magnetic locking system of claim 5 wherein the said spiral arc has an angular length, starting from the middle center of said recessed opening inner wall, equal to 90 degrees divided by the number of permanent magnets sets contained in each assembly.

16. The self-actuating magnetic locking system of claim 1 wherein the least one set of diametrically opposed protruding elements are integrated with a spring or flexion system that allows the protruding elements to fully retract inside the inner cylindrical aperture housing wall of the female assembly.

17. The self-actuating magnetic locking system of claim 1 wherein the least one set of diametrically opposed protruding elements are shaped to allow a seamless retraction of themselves by a force of a rounded top edging of the cylindrical projecting male member pushing onto the protruding elements when the cylindrical the projecting male member is inserted into the inner cylindrical aperture housing of the female assembly.

18. The self-actuating magnetic locking system of claim 1 wherein the locking condition where the projecting male member is magnetically drawn into the inner cylindrical aperture housing of the female assembly is rotationally aligned and where the protruding elements are fully extended in a radial manner beyond inner cylindrical aperture housing wall of the female assembly and into the recessed groove openings of the said cylindrical projecting male member wall.

19. The self-actuating magnetic locking system of claim 1 wherein the protruding elements are further shaped to allow a seamless rotation of themselves inside the recessed groove.

20. The self-actuating magnetic locking system of claim 1 wherein the at least one set of diametrically opposed recessed grooves allow a relative counter-clockwise rotation of the protruding elements inside said grooves engendering the transition of the said protruding elements from their natural protruding positions in locked condition to their retracted position inside the inner cylindrical aperture housing wall of the female assembly in unlocked condition.

21. The self-actuating magnetic locking system of claim 1 wherein at least one of the male assembly and the female assembly consisting of an interconnected outer axial ring.

22. The self-actuating magnetic locking system of claim 21 wherein the interconnected outer revolving ring is held in a fixed axial direction as the male assembly and the female assembly are drawn near each other.

23. The self-actuating magnetic locking system of claim 21 wherein the other said male or female assembly which does not include the said interconnected outer axial ring is held in a fixed axial direction as the said male and female assemblies are drawn near each other.

24. The self-actuating magnetic locking system of claim 1 wherein the male assembly and the female assembly consisting of an equal quantity of at least one set of protruding elements and grooves.

25. The self-actuating magnetic locking system of claim 1 wherein the at least one set of protruding elements are preferably equal to the quantity of sets of permanent magnets contained in each assembly.

26. The self-actuating magnetic locking system of claim 1 wherein the locking condition can only be disengaged by a manual counter-clockwise relative rotation of either the said male or female assembly interconnected with the said outer revolving ring that is manually or mechanically held in a fixed axial direction.

27. The self-actuating magnetic locking system of claim 26 wherein the manual counter-clockwise relative rotation in which the required relative counter-clockwise rotation angle required to disengage the assembly into unlocked condition is superior to the spiral arc angular length.

28. The self-actuating magnetic locking system of claim 1 where in the unlocked condition the at least one set of magnets contained in the male assembly and the female assembly enter mutual magnetic repulsion, repelling the male assembly and the female assembly from each other by a mutual magnetic repulsive force.

29. The self-actuating magnetic locking system of claim 1 wherein the at least one set of magnets are NdFeB Neodymium.

30. The self-actuating magnetic locking system of claim 1 wherein the at least one set of magnets are made of other permanent magnetic material or composite.

31. The self-actuating magnetic locking system of claim 1 wherein the male assembly and female assembly are made of a rigid plastic composite material or of a non-magnetically conductive material.

32. The self-actuating magnetic locking system of claim 1 wherein the interconnected outer revolving ring is made of a rigid plastic composite material or of a magnetically non conductive metal.

33. The self-actuating magnetic locking system of claim 1 wherein the interconnected outer revolving ring is a cover.

34. The self-actuating magnetic locking system of claim 1 wherein the protruding element and spring or flexion system are made of a plastic composite material or of a magnetically non conductive metal.
